(19) United States
(12) Patent Application Publication
(10) Pub. No.: US 2006/0059021 A1
(43) Pub. Date: Mar. 16, 2006

(54) Independent adjuster advisor

(76) Inventors: Jim Yulman, Philadelphia, PA (US); Steve Gantt, Blythewood, SC (US); Dana Meiser, Media, PA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/943,806

(22) Filed: Sep. 15, 2004

(51) Int. Cl. G06Q 40/00

(52) U.S. Cl. 705/4

(57) ABSTRACT

In various embodiments, assignments may be managed between a user system and a computer system. For example, insurance companies may manage assignments made to adjusters. Assignments may be assigned to vendors. Vendors may access an assignment program and transmit billing information and/or transmit reports to a computer system about assigned assignments. Billing information may be automatically and/or manually audited. Users may be able to correct errors discovered during audits of billing information. Bills without errors and/or bills with corrected errors may be automatically authorized and/or paid.

### BACKGROUND OF THE INVENTION

1. Field of the Invention

The present invention generally relates to computer systems. In particular, embodiments relate to systems and methods of managing assignments on a computer system. In some embodiments, the present invention relates to systems and methods of managing assignments to outsourced vendors and the subsequent processing and auditing of those vendor's invoices on a computer system

2. Brief Description of the Related Art

Companies often outsource tasks to independent vendors and internally assign tasks to be completed. Currently, an insurance company faxes assignments to independent adjusters who then complete the task and submit a bill to the company. Bills may vary among different adjusters and each bill may need to be individually reviewed and authorized manually. It may be desirable to utilize a system for managing assignments and uniformly collecting and auditing invoices.

During the past several years, many insurance companies and financial service organizations have been using computer-based systems to process, evaluate, analyze, and estimate thousands of claims in a fair and consistent manner. In the past, such systems have been limited to traditional computing architectures such as mainframes and stand-alone personal computers. Therefore, it was necessary to install and maintain client software as well as server software for these systems in particular physical locations. With the growth of the Internet, however, many personal computers may now be granted client access to servers distributed all over the world. It may be desirable to utilize a system for managing assignments that is configured to be accessed over the Internet or through a web browser.

### SUMMARY OF THE INVENTION

Herein we describe systems and methods for managing and storing assignments in a computer system. An assignment program may be used to managing assignments between a vendor and a company. In some embodiments, a user may access assignments through a user system. Assignments may be stored on a memory of a computer system. Assignments may be created in the assignment program or transmitted to the computer system. Tasks may be added to one or more pending assignments. A user may access assignments through a website coupled to the computer system. An assignment program may allow assignments to be created and/or assigned to vendors. Assignments may be automatically or manually assigned to vendors. Vendors may accept or decline assignments.

In certain embodiments, vendors may use the assignment program to transmit billing information to a computer system. Billing information may include billing codes. Billing codes may allow different vendors to submit invoices using similar formats. Billing information may include tasks and/or assignments a vendor has completed. Billing information may include the amount of time spent on a task or assignment and/or an amount of money a vendor charges to complete a task. Billing information may be audited automatically and/or manually. Billing information may be audited before or after transmission to the computer system. A vendor may be allowed to correct errors discovered in billing during auditing. A vendor may also transmit a work product report to a computer system that includes information requested by a company and/or a list of tasks completed by the vendor.

In some embodiments, an assignment program may automatically pay at least some of the bills in the transmitted billing information. An assignment program may pay bills that do not exceed a predetermined amount. An assignment program may automatically pay bills when an auditing program of the assignment program does not identify any errors. In an embodiment, bills with corrected errors may be automatically paid.

In some embodiments, an assignment program may be used to manage and store assignments from an insurance processing system to an adjuster. An adjuster may access assignments through a user system. Assignments may be stored on a memory of an insurance processing system. Assignments may be created in the assignment program or transmitted to the insurance processing system. Tasks may be added to one or more pending assignments. An adjuster may access assignments through a website coupled to the insurance processing system or through the Internet. Assignments may be automatically or manually assigned to adjusters. Adjusters may accept or decline assignments.

In some embodiments, adjusters may use the assignment program to transmit billing information to the insurance processing system. Billing information may include billing codes. Billing codes may allow different vendors to submit invoices using similar formats. Billing information may include tasks and/or assignments an adjuster has completed. Billing information may include the amount of time spent on a task or assignment and/or an amount of money an adjuster charges to complete a task. Billing information may be audited automatically and/or manually. Billing information may be audited before or after transmission to the computer system. An adjuster may be allowed to correct errors discovered in billing during auditing. An adjuster may also transmit a work product report to a computer system that includes information requested by a company and/or a list of tasks completed by the adjuster.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 illustrates a flowchart of an embodiment for managing assignments;

FIG. 2 illustrates an embodiment of a view of an assignment in an assignment program;

FIG. 3 illustrates an embodiment of a task list; and

FIG. 4 illustrates an embodiment of billing information.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF EMBODIMENTS

Herein we describe a system and method for the managing assignments between a user system and a computer system. Assignments may be managed between a user's computer system or user system and a computer system. A user system may be a computer system used by a user, such as a vendor. A user system may be coupled to a computer system, such as an insurance processing system, a financial service organization system, and/or a server. Wires, wide area networks (“WAN”), local area networks (“LAN”), and combinations thereof may couple user system and another computer system. A WAN may be a network that spans a relatively large geographical area. The Internet is an example of a WAN. A WAN may include a variety of heterogeneous computer systems and networks that may be interconnected in a variety of ways and that may run a variety of software applications.

One or more LANs may be coupled to a WAN. A LAN may be a network that spans a relatively small area compared to a WAN. A LAN may be confined to a single building or group of buildings. Each node (e.g., user system, individual computer system or device) on a LAN may have its own CPU with which it may execute programs, and each node may also be able to access data and devices anywhere on a LAN. A LAN may allow many users to share devices (e.g., printers) and data stored on file servers. A LAN may be characterized by a variety of types of topology (e.g., the geometric arrangement of devices on the network), of protocols (e.g., the rules and encoding specifications for sending data, and whether the network uses a peer-to-peer or user/server architecture), and of media (e.g., twisted-pair wire, coaxial cables, fiber optic cables, and/or radio waves). A LAN may be coupled to other computer systems and/or other devices and/or other LANs through a WAN.

One or more mainframe computer systems may be coupled to a WAN. A mainframe may be coupled to a storage device or file server and mainframe terminals. A computer system, such as an insurance processing system or financial service organization system, may include a combination of mainframes and/or mainframe terminals. Mainframe terminals may access data stored in the storage device or file server coupled to or included in mainframe computer system. A user system may be a mainframe terminal.

A WAN may also include computer systems (e.g., user systems, insurance claim processing systems, financial service organization systems, etc.) connected to a WAN individually and not through a LAN. For example, WAN may include computer systems that may be geographically remote and connected to each other through the Internet.

A computer system (e.g., user systems, insurance claim processing systems, financial service organization systems, etc.) may also include a display device such as a monitor, an alphanumeric input device such as a keyboard, and a directional input device such as a mouse. A computer system (e.g., user systems, insurance claim processing systems, financial service organization systems, etc.) may typically include components such as a CPU with an associated memory such as floppy disks and/or CD-ROMs. Memory may store program instructions for computer programs. Program instructions may be executable by a CPU. The term “memory” is intended to include any installation medium, e.g., a CD-ROM or floppy disks, a computer system memory such as DRAM, SRAM, EDO RAM, Rambus RAM, etc., or any non-volatile memory such as a magnetic media, e.g., a hard drive or optical storage. Memory may also include other types of memory or combinations thereof. In addition, memory may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory.

A computer system may be operable to execute computer programs. It may be desirable to utilize a knowledge-based system for assignment management which is configured to be accessed over the Internet or through a web browser, such as those described in the following applications, which are fully incorporated herein by reference as if set forth herein:

U.S. patent application Ser. No. 09/603,307 to Childress et al., entitled “SYSTEM AND METHOD FOR PROCESSING INSURANCE CLAIMS USING A TABLE OF CONTENTS” filed on Jun. 23, 2000;

U.S. patent application Ser. No. 09/603,129 to Jones, entitled “SYSTEM AND METHOD FOR IDENTIFYING CRITICAL FACTORS AFFECTING AN ESTIMATED VALUE INCLUDED IN AN INSURANCE CLAIM CONSULTATION REPORT” filed on Jun. 23, 2000;

U.S. patent application Ser. No. 09/603,662 to Childress, entitled “RELEVANCE CALCULATION FOR A REFERENCE SYSTEM IN AN INSURANCE PROCESSING SYSTEM” filed on Jun. 23, 2000;

U.S. patent application Ser. No. 09/603,308 to Wolfe et al., entitled “SYSTEM AND METHOD FOR EXTERNALIZATION OF FORMULAS FOR ASSESSING DAMAGES” filed on Jun. 23, 2000;

U.S. patent application Ser. No. 09/603,144 to Jones et al., entitled “SYSTEM AND METHOD FOR EXTERNALIZATION OF RULES FOR ASSESSING DAMAGES” filed on Jun. 23, 2000;

U.S. patent application Ser. No. 09/602,687 to Lorenz, entitled “WEB-ENABLED SYSTEM AND METHOD FOR ASSESSING DAMAGES” filed on Jun. 23, 2000;

PCT Patent Application No. PCT/US01/20030 to Jones et al., entitled “SYSTEM AND METHOD FOR PROCESSING INSURANCE CLAIMS” filed on Jun. 21, 2001;

U.S. patent application Ser. No. 09/603,302 to Childress, entitled “DYNAMIC HELP SYSTEM FOR AN INSURANCE PROCESSING SYSTEM” filed on Jun. 23, 2000;

U.S. patent application Ser. No. 09/602,691 to Childress, entitled “GRAPHICAL USER INTERFACE WITH A HIDE/SHOW FEATURE FOR A REFERENCE SYSTEM IN AN INSURANCE PROCESSING SYSTEM” filed on Jun. 23, 2000;

U.S. patent application Ser. No. 09/603,130 to Lorenz, entitled “RESET BUTTON FOR WEB-ENABLED SYSTEM AND METHOD FOR ASSESSING DAMAGES” filed on Jun. 23, 2000;

U.S. patent application Ser. No. 09/603,303 to Lorenz, entitled “INTERNET-ENABLED SYSTEM AND METHOD FOR ASSESSING DAMAGES” filed on Jun. 23, 2000;

U.S. patent application Ser. No. 09/603,304 to Lorenz, entitled “PRICING MODELS FOR WEB-ENABLED SYSTEM AND METHOD FOR ASSESSING DAMAGES” filed on Jun. 23, 2000;

U.S. patent application Ser. No. 09/603,306 to Wolfe, entitled “SYSTEM AND METHOD FOR DISPLAYING MESSAGES USING A MESSAGES TABLE” filed on Jun. 23, 2000;

U.S. patent application Ser. No. 10/422,632 to Wahlbin, entitled “GRAPHICAL INPUT DISPLAY IN AN INSURANCE PROCESSING SYSTEM” filed on Apr. 24, 2003;

U.S. patent application Ser. No. 10/422,450 to Wahlbin et al., entitled “METHOD AND SYSTEM FOR DETERMINING MONETARY AMOUNTS IN AN INSURANCE PROCESSING SYSTEM” filed on Apr. 24, 2003;

U.S. patent application Publication No. 2004-0054557 published on Mar. 18, 2004 to Wahlbin et al., entitled “COMPUTERIZED METHOD AND SYSTEM FOR ESTIMATING PREMISES LIABILITY FOR AN ACCIDENT” filed on Sep. 9, 2002;

U.S. patent application Publication No. 2004-0054558 published on Mar. 18, 2004 to Wahlbin et al., entitled “COMPUTERIZED METHOD AND SYSTEM FOR DETERMINING CLAIMANT STATUS IN PREMISES LIABILITY FOR AN ACCIDENT” filed on Sep. 9, 2002;

U.S. patent application Publication No. 2004-0049409 published on Mar. 11, 2004 to Wahlbin et al., entitled “COMPUTERIZED METHOD AND SYSTEM FOR DETERMINING BREACH OF DUTY IN PREMISES LIABILITY FOR AN ACCIDENT” filed on Sep. 9, 2002;

U.S. patent application Publication No. 2004-0054556 published on Mar. 18, 2004 to Wahlbin et al., entitled “COMPUTERIZED METHOD AND SYSTEM FOR DETERMINING CAUSATION IN PREMISES LIABILITY FOR AN ACCIDENT” filed on Sep. 9, 2002;

U.S. patent application Publication No. 2004-0054559 published on Mar. 18, 2004 to Wahlbin et al., entitled “COMPUTERIZED METHOD AND SYSTEM FOR DETERMINING THE CONTRIBUTION OF DEFENSES TO PREMISES LIABILITY FOR AN ACCIDENT” filed on Sep. 9, 2002;

U.S. patent application Publication No. 2002-0069091 published on Jun. 6, 2002 to Wahlbin et al., entitled “COMPUTERIZED METHOD OF LIABILITY ASSESSMENT FOR AN ACCIDENT” filed on Oct. 2, 2001;

U.S. patent application Publication No. 2002-0082873 published on Jun. 27, 2002 to Wahlbin et al., entitled “COMPUTERIZED METHOD AND SYSTEM OF DETERMINING RIGHT OF WAY AND LIABILITY FOR AN ACCIDENT” filed on Oct. 2, 2001;

U.S. patent application Publication No. 2002-0062234 published on May 23, 2002 to Wahlbin et al., entitled “COMPUTERIZED METHOD AND SYSTEM OF ESTIMATING LIABILITY AND RANGE OF LIABILITY FOR AN ACCIDENT” filed on Oct. 2, 2001;

U.S. patent application Publication No. 2002-0055860 published on May 9, 2002 to Wahlbin et al., entitled “COMPUTERIZED METHOD AND SYSTEM OF DETERMINING RIGHT OF WAY IN AN ACCIDENT” filed on Oct. 2, 2001;

U.S. patent application Publication No. 2002-0062233 published on May 23, 2002 to Wahlbin et al., entitled “COMPUTERIZED METHOD AND SYSTEM OF ASSESSING LIABILITY FOR AN ACCIDENT USING IMPACT GROUPS” filed on Oct. 2, 2001;

U.S. patent application Publication No. 2002-0059097 published on May 16, 2002 to Wahlbin et al., entitled “COMPUTERIZED METHOD AND SYSTEM OF ASSIGNING AN ABSOLUTE LIABILITY VALUE FOR AN ACCIDENT” filed on Oct. 2, 2001;

U.S. patent application Publication No. 2002-0087363 published on Jul. 4, 2002 to Wahlbin et al., entitled “COMPUTERIZED METHOD AND SYSTEM OF LIABILITY ASSESSMENT FOR AN ACCIDENT USING ENVIRONMENTAL, VEHICLE, AND DRIVER CONDITIONS AND DRIVER ACTIONS” filed on Oct. 2, 2001;

U.S. patent application Publication No. 2002-0091504 published on Jul. 11, 2002 to Wahlbin et al., entitled “COMPUTERIZED METHOD AND SYSTEM FOR ACCUMULATING LIABILITY ESTIMATES” filed on Oct. 2, 2001;

U.S. patent application Publication No. 2002-0128881 published on Sep. 12, 2002 to Wahlbin et al., entitled “COMPUTERIZED METHOD AND SYSTEM FOR ADJUSTING LIABILITY ESTIMATES IN AN ACCIDENT LIABILITY ASSESSMENT PROGRAM” filed on Oct. 2, 2001;

U.S. patent application Publication No. 2002-0062232 published on Sep. 12, 2002 to Wahlbin et al., entitled “COMPUTERIZED METHOD AND SYSTEM FOR ADJUSTING LIABILITY ESTIMATION FACTORS IN AN ACCIDENT LIABILITY ASSESSMENT PROGRAM” filed on Oct. 2, 2001;

U.S. patent application Publication No. 2002-0062235 published on May 23, 2002 to Wahlbin et al., entitled “COMPUTERIZED METHOD AND SYSTEM FOR PROVIDING CLAIMS DATA TO AN ACCIDENT LIABILITY ASSESSMENT PROGRAM” filed on Oct. 2, 2001;

U.S. patent application Publication No. 2002-0059084 published on May 16, 2002 to Wahlbin et al., entitled “COMPUTERIZED METHOD AND SYSTEM OF DISPLAYING AN ACCIDENT TYPE” filed on Oct. 2, 2001;

U.S. patent application Publication No. 2002-0059086 published on May 16, 2002 to Wahlbin et al., entitled “COMPUTERIZED METHOD AND SYSTEM OF DISPLAYING A ROADWAY CONFIGURATION RELATING TO AN ACCIDENT” filed on Oct. 2, 2001;

U.S. patent application Publication No. 2002-0059087 published on May 16, 2002 to Wahlbin et al., entitled “COMPUTERIZED METHOD AND SYSTEM OF DISPLAYING AN IMPACT POINT RELATING TO AN ACCIDENT” filed on Oct. 2, 2001;

U.S. patent application Publication No. 2002-0059083 published on May 16, 2002 to Wahlbin et al., entitled “COMPUTERIZED METHOD AND SYSTEM OF DETERMINING INCONSISTENCIES IN WITNESS STATEMENTS RELATING TO

AN ACCIDENT” filed on Oct. 2, 2001;

U.S. patent application Publication No. 2002-0049619 published on Apr. 25, 2002 to Wahlbin et al., entitled “COMPUTERIZED METHOD AND SYSTEM OF IDENTIFYING A CREDIBLE WITNESS STATEMENT RELATING TO AN ACCIDENT” filed on Oct. 2, 2001;

U.S. patent application Publication No. 2002-0059085 published on May 16, 2002 to Wahlbin et al., entitled “COMPUTERIZED METHOD AND SYSTEM OF DETERMINING A CREDIBLE REAL SET OF CHARACTERISTICS FOR AN ACCIDENT” filed on Oct. 2, 2001;

U.S. patent application Publication No. 2004-0103008 published on May 27, 2004 to Wahlbin et al., entitled “COMPUTERIZED METHOD AND SYSTEM FOR ESTIMATING LIABILITY FOR AN ACCIDENT FROM AN INVESTIGATION OF THE ACCIDENT” filed on Nov. 27, 2002;

U.S. patent application Publication No. 2004-0111301 published on Jun. 6, 2004 to Wahlbin et al., entitled “COMPUTERIZED METHOD AND SYSTEM FOR ESTIMATING LIABILITY FOR AN ACCIDENT USING DYNAMIC GENERATION OF QUESTIONS” filed on Nov. 27, 2002;

U.S. patent application Publication No. 2004-0103010 published on May 27, 2004 to Wahibin et al., entitled “COMPUTERIZED METHOD AND SYSTEM FOR ESTIMATING AN EFFECT ON LIABILITY OF THE SPEED OF VEHICLES IN AN ACCIDENT AND TIME AND DISTANCE TRAVELED BY THE VEHICLES” filed on Nov. 27, 2002;

U.S. patent application Publication No. 2004-0103004 published on May 27, 2004 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES IN AN ACCIDENT AND TIME AND DISTANCE TRAVELED BY THE VEHICLES IN A MERGING VEHICLE ACCIDENT” filed on Nov. 27, 2002;

U.S. patent application Publication No. 2004-0103006 published on May 27, 2004 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES WITH A SPECIFIED SPEED” filed on Nov. 27, 2002;

U.S. patent application Publication No. 2004-0102985 published on May 27, 2004 to Wahlbin et al., entitled “COMPUTERIZED METHOD AND SYSTEM FOR ESTIMATING AN EFFECT ON LIABILITY BASED ON THE STOPPING DISTANCE OF VEHICLES” filed on Nov. 27, 2002;

U.S. patent application Publication No. 2004-0103007 published on May 27, 2004 to Wahlbin et al., entitled “COMPUTERIZED METHOD AND SYSTEM FOR ESTIMATING AN EFFECT ON LIABILITY USING CLAIM DATA ACCESSED FROM CLAIM REPORTING SOFTWARE” filed on Nov. 27, 2002;

U.S. patent application Publication No. 2004-0103009 published on May 27, 2004 to Wahlbin et al., entitled “COMPUTERIZED METHOD AND SYSTEM FOR CREATING PRE-CONFIGURED CLAIM REPORTS INCLUDING LIABILITY IN AN ACCIDENT ESTIMATED USING A COMPUTER SYSTEM” filed on Nov. 27, 2002;

U.S. patent application Publication No. 2004-0102984 published on May 27, 2004 to Wahlbin et al., entitled “COMPUTERIZED METHOD AND SYSTEM FOR ESTIMATING LIABILITY USING RECORDED VEHICLE DATA” filed on Nov. 27, 2002;

U.S. patent application Publication No. 2004-0103005 published on May 27, 2004 to Wahlbin et al., entitled “COMPUTERIZED METHOD AND SYSTEM FOR ESTIMATING MONETARY DAMAGES DUE TO INJURIES IN AN ACCIDENT FROM LIABILITY ESTIMATED USING A COMPUTER SYSTEM” filed on Nov. 27, 2002;

U.S. patent application Ser. No. 10/790,632 to Woods et al., entitled “SYSTEMS AND METHODS FOR A GRAPHICAL INPUT DISPLAY IN AN INSURANCE PROCESSING SYSTEM” filed on Mar. 1, 2004;

U.S. patent application Ser. No. 10/790,626 to Lorenz, entitled “SYSTEMS AND METHODS FOR USING DATA STRUCTURE LANGUAGE IN WEB SERVICES” filed on Mar. 1, 2004;

U.S. patent application Ser. No. 10/786,572 to Osborne, entitled “SYSTEMS AND METHODS FOR PRINTING AN INSURANCE DOCUMENT” filed on Feb. 25, 2004;

U.S. patent application Ser. No. 10/838,159 to Van Hutten et al., entitled “SYSTEM AND METHOD FOR CAPTURING AN IMAGE” filed on May 3, 2004; and

U.S. patent application to Van Hutten et al., entitled “SYSTEM AND METHOD FOR UNDERWRITING” filed on Sep. 1, 2004.

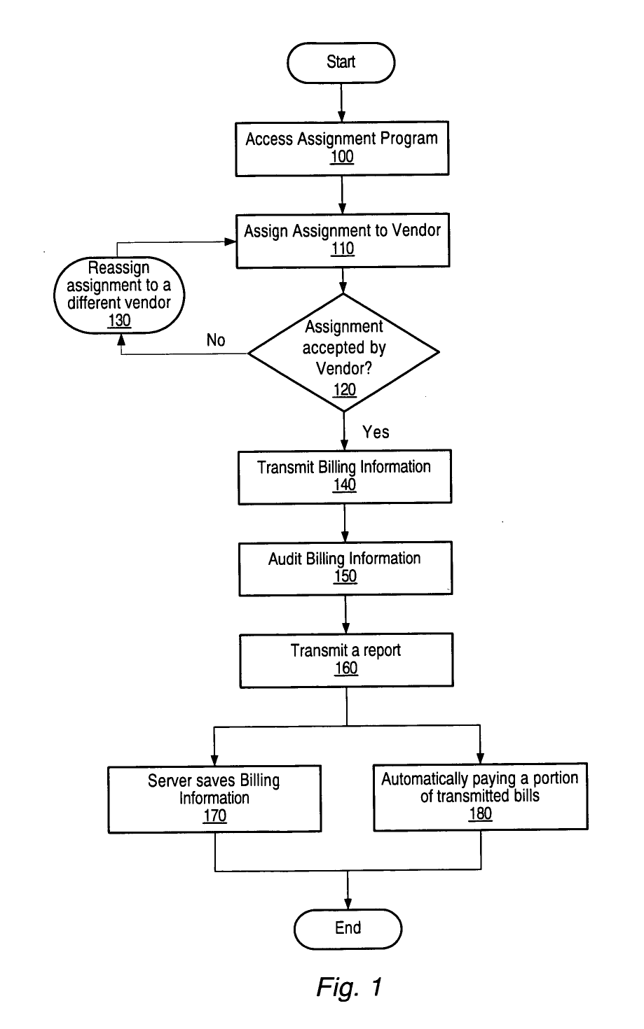

An assignment program may manage assignments between a company and a vendor. A vendor may be any entity or individual that performs one or more activities for a company at the request of a company. A vendor may be an independent or a part of the company. In some embodiments, a vendor may include an insurance adjuster. FIG. 1 depicts a flowchart of an embodiment of managing assignments using an assignment program. Managing assignments may include accessing an assignment program stored on a memory of a computer system from a user system 100. A computer system may be accessed via one or more Internet protocols, such as HTML and/or TCP/IP. Assignments may be assigned to one or more vendors 110. A program on the computer system may automatically assign assignments to one or more adjusters. An assignment may include one or more tasks. A vendor may accept or decline assignments 120. A declined assignment may be reassigned to a different vendor 130.

In some embodiments, adjusters may transmit billing information to a computer system for one or more assignments 140. A user may transmit billing information from a user system to a computer system. A user may access a website coupled to the computer system to transmit billing information to the computer system. A user may enter billing information on a website coupled to the computer system. A user may upload billing information via a website coupled to the computer system. Billing information may be audited at least partially on the computer system 150. In some embodiments, billing information may be audited at least partially on a user system. A user may enter billing information on a user system and the billing information may be automatically audited. The user may be prompted to alter portions of billing information that the audit flagged or found errors in. A user may transmit a report to the computer system 160. In one embodiment, a report may include information requested in an assignment. Billing information may be stored on a memory of a computer system 170. In some embodiments, at least a portion of submitted bills may be automatically paid 180.

Assignments may be assigned to individuals or groups of individuals to complete. Assignments may include any request for an individual to accomplish a task or activity. Assignments may include, but are not limited to, investigating an insurance claim, investigating a financial transaction, and/or investigating an insurance policy request. Assignments may also include any outsourced activities or activities performed by individuals within a company. In certain embodiments, assignments may relate to the insurance industry and/or financial industry.

In some embodiments, an assignment program may include one or more templates to facilitate creation of assignments. Information about an assignment may be entered in one or more fields of the template. Some information may be automatically entered in fields of a template. For example, an assignment identification code may be automatically assigned to an assignment. In some embodiments, entering a task code in a template may cause the assignment program to automatically complete fields for task description, task instructions, type of billing rate (e.g., flat or hourly), billing rate, and/or required professional category. Automatically entered fields may be manually altered. In certain embodiments, some automatically entered fields may not be altered. For example, a user creating an assignment may not alter a billing rate associated with a task manually.

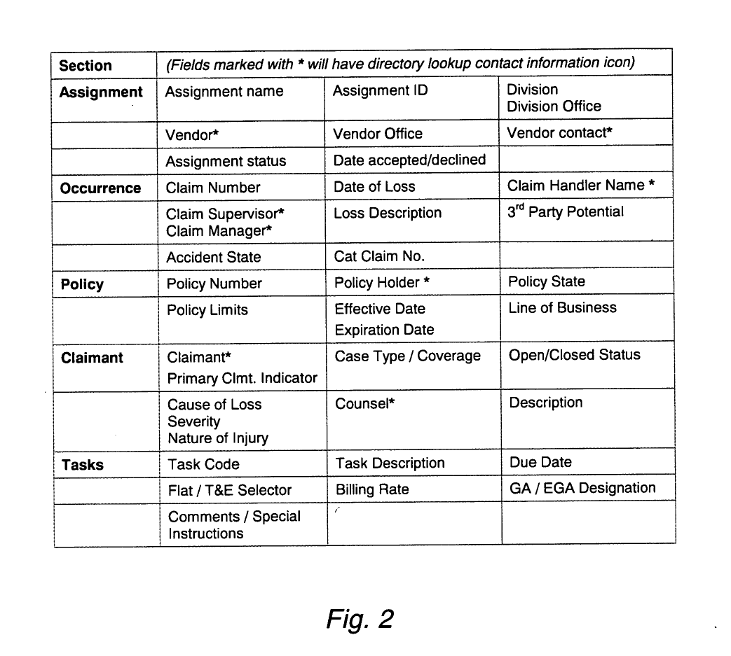

Assignments may be viewed through the assignment program. FIG. 2 depicts an embodiment of information viewable through an assignment program. As depicted in FIG. 2, a plurality of information about an assignment may be viewed. Information about an assignment may be viewed in a window of a web browser. A user accessing an assignment through an assignment program may be able to view and/or modify information including, but not limited to assignment name, assignment identification code, division or division office, vendor name, vendor office, vendor code, a contact at the vendor, assignment status, date an assignment was accepted or declined, claim number, date of loss, claim handler name, claim supervisor and/or manager, description of loss, potential third party witnesses, potential third party beneficiaries, accident state, accident city, accident zip, policy number, policy holder, policy state, policy limits, effective date of the policy, expiration date of the policy, type of policy, claimant name, assignment type, policy coverage of the type of claim, status of the claim, severity of the loss, nature of the injury, cause of the loss, attorneys associated with the policy holder and/or claimant, miscellaneous text fields that a user can enter information in, tasks associated with the assignment, task codes, task descriptions, task due date, task billing rates, task completion costs, whether the task requires a vendor with a specific professional category, and/or any special instructions.

Assignments may include one or more tasks. A task may be a request for a specific activity to be performed. Tasks may include examining medical reports, examining police reports, examining the property for which insurance coverage is requested, examining accident sites, obtaining medical reports, obtaining an account of events from an insured and/or claimant, obtaining receipts and/or copies of signatures from financial transactions, obtaining images of accident sites, obtaining images of property insurance coverage is requested for, obtaining images of property used to secure a loan, obtaining images of the property for which a loan is requested, and/or obtaining vehicle identification numbers.

Often the same tasks may be included with similar assignments. In some embodiments, tasks to be included in an assignment may be selectable from a list of tasks. A task list may be customizable. Tasks in a task list may be coupled to billing codes for use when submitting billing information. An assignment program may automatically include certain tasks when selecting a specific type of assignment. For example, automobile insurance claims may always include tasks such as confirming loss/damage, determine if any injuries occurred as a result of the accident, and/or obtaining a police report. Automatically creating a task list for categories of assignments may increase efficiency, increase uniformity among similar claims assigned to different vendors, and reduce time spent entering assignments. Assignments may be obtained from a database of pending claims and/or cases. Assignments may be created in the assignment program. Tasks available to be included in an assignment may vary depending on the type of assignment and/or amount of the claim. In one embodiment, selecting tasks from a task list may automatically generate an assignment letter. When the assignment is assigned to a vendor the assignment letter may be transmitted to the vendor and include information about the assignment.

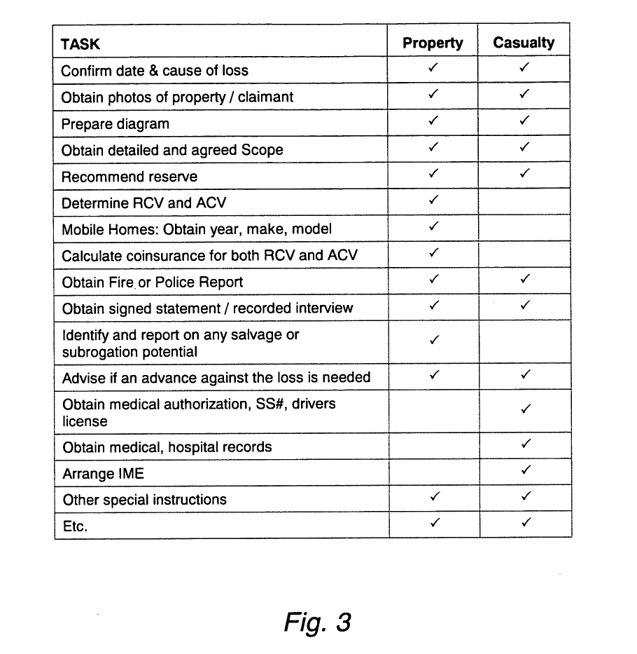

As depicted in FIG. 3, a task list may include recommendations for each type of assignment. Tasks that can be included in an assignment may vary depending on the type of assignment. For example, different tasks may be included for assignments including insurance claims based on property losses versus casualty losses. In one embodiment, an assignment program may include a default type of assignment. By eliminating certain tasks from available options that are not relevant to an assignment, creation of assignments may be streamlined. For example, a task may include determining a mobile home's make, model, and/or year may be relevant for property losses and irrelevant for casualty losses, and so the task may not be an available option for assignments relating to casualty losses.

In some embodiments, a user may also choose to deselect recommended tasks in a task list. A user may also create custom tasks to be included in an assignment. In some embodiments, a task list may include optional tasks to reduce the number of custom tasks a user may have to create. In some embodiments, certain tasks in a task list may not be deselected. Required tasks in a task list may be based on industry custom, company policy, and/or federal or state regulations. Each task may also include instructions and/or a link to instructions regarding the task. Special instructions for a task may also be included and/or entered by a user. In one embodiment, custom created tasks may be automatically routed to manual audits. Tasks in the task list may be coupled to billing codes for use when submitting billing information.

Tasks may be added to pending assignments before and/or after assigning an assignment to a vendor. Tasks may be assigned a flat or an hourly rate. A task may have a maximum amount of time that may be spent on the task. A rate assigned to a task may be based on to whom the task is assigned. A rate a task is assigned may be based on factors including, but not limited to, state where the service requests is to be performed, type of business, type of assignment, professional category of the assigned vendor, and/or type of loss. A rate may be assigned to a task automatically. In some embodiments, a user may modify rates. Automatically assigning a rate to a task automatically facilitates assignment entry and increases uniformity and cost-effectiveness by ensuring similar vendors get paid similarly.

In some embodiments, assignments may be stored on a memory of a computer system, such as an insurance processing system. Assignments may be stored in a database of a computer system. In some embodiments, a user may interact with a computer system through the Internet. Users may also communicate with a computer system through other networks including, but not limited to, a WAN or a LAN. In some embodiments, a data structure language (e.g., XML, Web Service Description Language (WSDL), and/or other markup languages (e.g., hyper text markup language (HTML)) may be used for communications between a user and a computer system. In some embodiments, WSDL may define an interface for a web service including available operations, the protocol that the user should use to invoke the web service, and the type of data the web service expects.

A user may access assignments from a user system. Assignments may be accessed via one or more Internet protocols, such as HTML and/or TCP/IP. A user may be able to view assignments assigned to the user. Some users may have access to different features or have different permissions from other users. For example, a first user may be able to create and/or assign assignments to other users, override automatic assignments, and/or view all pending assignments. Other users may only be able to view assignments assigned to specific users, such as a group a user manages. In one embodiment, a user may only be able to access assignments assigned to the user.

In some embodiments, a user may access a website coupled to an insurance processing system. A user may be able to access a program or subroutine that manages assignments through the website. A website may be encrypted using, for example, IIS SSL 128-bit encryption. A website may require user authentication prior to granting the user access to the website. Certain users may only be granted permission to view and/or alter certain portions of the website.

In certain embodiments, the assignment program may run when a link or icon in a section of a web browser is selected. The assignment program may be user or client based. In some embodiments, the assignment program may be accessible through the computer system. In some embodiments, an assignment program may be at least partially executed on a computer system coupled to an insurance processing system. An advantage to a non-client based application may be that upgrades may be performed globally on the computer system. Each client or user may not need to individually upgrade an assignment program located on the user system. A user's access to an assignment program may increase by allowing access to the assignment program through a web browser. A user may not need to download or install additional software on the user system to operate the assignment program. By accessing the assignment program through a web browser linked to computer system, such as an insurance processing system, a user may access the assignment program from any computer that has access to the Internet. A further advantage may be that when assignments are stored on a database of a computer system, the assignments may be accessible from multiple locations or from any computer connected to the Internet.

In some embodiments, using an assignment program may facilitate and increase effectiveness of monitoring assignments. Assignments may be manually or automatically assigned to one or more vendors, such as an insurance adjuster. An assignment program may allow electronic assignment of assignments and/or tasks to vendors. A user may assign assignments based on business rules and/or factors such as, vendor skills and/or vendor workload. A notice or email may be sent to a vendor to indicate an assignment has been assigned to the vendor. A notice may be automatically transmitted to the vendor once an assignment has been assigned to the vendor. A notice may notify vendors of assignments with past due deadlines or rush projects. Currently, insurance adjusters may receive a fax indicating what assignments have been assigned to the adjuster. A notice may include a copy of the assignment and/or a link to a website where an vendor can view the assignment. A user may have to login to the website to view the page to which the link in the email directed the user. Security protocols may be in place restricting access to an assignment program to authorized personnel (e.g., specific vendors).

A vendor may be able to accept or decline the assignment. A vendor may provide a reason for declining an assignment, such as being unable to complete the assignment within a specified time frame. In some embodiments, a user may be able to ask questions about the assignment before accepting or declining the assignment. In some embodiments, the assignment program may automatically answer some of the questions about the assignment. For example, questions concerning the amount of money that can be received for completing the bill, who assigned the bill, what is the expected timeframe for completion of the assignment, and/or how long the assignment is expected to take may be answered automatically by the assignment program. A user may ask questions via XML messages and/or emails to the computer system. A user may ask questions by filling out templates on a website.

In some embodiments, a copy of the assignment may be stored on a memory of the computer system. In certain embodiments, a vendor may log into a website and be able to view all assignments assigned to the vendor. Allowing vendors to access an assignment program via website may facilitate management of task loads by individual vendors and/or allow others to view progress in assignments from any computer connected to the Internet.

In some embodiments, an assignment program may automatically assign assignments to vendors. Assignments may be assigned based on business rules and/or a set of assignment rules. Assignment rules may assign assignments based on a vendor's workload; a vendor's experience; a vendor's location; a vendor's proximity to an incident site; a vendor's previous performance; a vendor's costs; and/or federal, state, and/or industry regulations. Vendors may be classified in professional categories. For example, there are several types of adjusters including general adjusters, executive general adjusters, and national general adjusters. In certain embodiments, certain tasks may be only performed by a vendor with a specific professional category and/or a higher professional category. In some embodiments, an assignment may be automatically assigned to a vendor whose qualifications meet the professional category required by the tasks in the assignment.

In some embodiments, an assignment program may include a list of vendors. Assignments may be assigned or automatically assigned to vendors on the list of vendors. Vendor lists may include approved and/or unapproved vendors. Assignments may be assigned to approved vendors before unapproved vendors, in certain embodiments. A vendor list may include a vendor's line of business, experience, expertise, vendor rating based on past experience and/or industry experience, and/or general costs. A vendor list may include vendor addresses, contact names and numbers, vendor tax identification numbers, and/or vendor bank account routing information. Assignments may be assigned automatically and/or manually to vendors on the vendor list. In some embodiments, a user may add vendors to a list. All users may not be able to access and/or modify vendor lists. All users may not be able to assign assignments to vendors on the vendor list. A vendor may be able to access and/or alter information about the vendor on the vendor list. A vendor may not be able to access and/or alter information about other vendors on vendor lists. In some embodiments, assignments may be at least partially assigned based on information in the vendor lists.

In some embodiments, assignments may be assigned at least partially based on location. A radius function may allow all vendors in a specified region to be identified. For example, all vendors in a zip code or within a specified distance from a location may be identified. The radius function may allow assignment of assignments to a vendor proximate a location, such as the location of the claimant, the location of the policyholder, and/or the location of the loss. A user may select a vendor within a radius of a location and/or an assignment program may select a vendor at least partially due to the vendor's proximity to a location.

In some embodiments, an assignment program may facilitate management of assignments. An assignment program may include lists of notices sent to vendors, to do lists, newly created assignments, newly submitted billing information and/or reports, and/or overdue activities. An assignment program may include a document manager. A document manager may save generated documents on a memory of a computer system. The document manager may save documents, such as reports and/or billing information, transmitted to a computer system.

An assignment program may also allow users (e.g., vendors, adjusters, etc.) to enter billing information. Billing information may include, but is not limited to, an amount of time a vendor spends on an assignment and/or task, a cost of completing the task, billing codes, a list of tasks completed and/or pending, and/or a plurality of amounts of time required to complete assignments for a plurality of vendors. Billing information may also include, but is not limited to, date of an invoice or bill; whether an invoice is an initial, an interim, or a final invoice; invoice code or number; policy coverage; claim code or number; claim office; company name or office; claimant name and/or code; assignment name or code; date of loss; state the loss occurred in; type of claim or assignment; total fee; total bill; total expenses; tracking number; agent number; policy number; client name; policyholder name; customer office; and/or coinsurance information.

Billing codes may be used in billing information and/or may identify common tasks and/or common amounts charged for tasks. Billing codes may include numbers and/or letters. Billing codes may include abbreviations. Using billing codes may facilitate generation of bills since they allow a user to quickly enter information. Using billing codes may also increase uniformity and consistency within an industry since a task or assignment with a specific billing code may always be treated similarly. However, when billing information is manually entered and reviewed, similar bills may be authorized for different amounts. Using billing codes may increase uniformity among bills from several different users and/or vendors. Using billing codes may decrease administrative time and increase adjuster efficiency.

Billing codes may be based on industry standards. Billing codes may vary between companies. Billing codes may be alterable and/or created by a user. In certain embodiments, when a vendor is paid for completion of a task a vendor may only need to send a billing code to be paid. In some embodiments, tasks assigned to a vendor may have corresponding codes. A company may pay a vendor a fixed amount for each completed task or a fixed amount for completing an assignment. A vendor may send a company a list of billing codes corresponding to completed tasks and/or pending tasks and a company may pay the vendor based on the list. Billing information may also include other information entered by a user. Allowing a vendor or user to enter additional information in billing information may be advantageous. For example, if an adjuster is assigned the task of obtaining police report and a police report was not filed, then an adjuster may list the task as complete and also enter “police report not filed.”

Billing information may include an identifier associated with a vendor. Who performed a task may be recognized from billing information by the identifier. An identifier may include the professional category of the vendor, such as general adjuster. In certain embodiments, an identifier may only include professional category of the vendor. Each professional category of vendors may be paid differently for the same tasks, and so identification of the professional category of the vendor performing the task may be necessary for bill calculation.

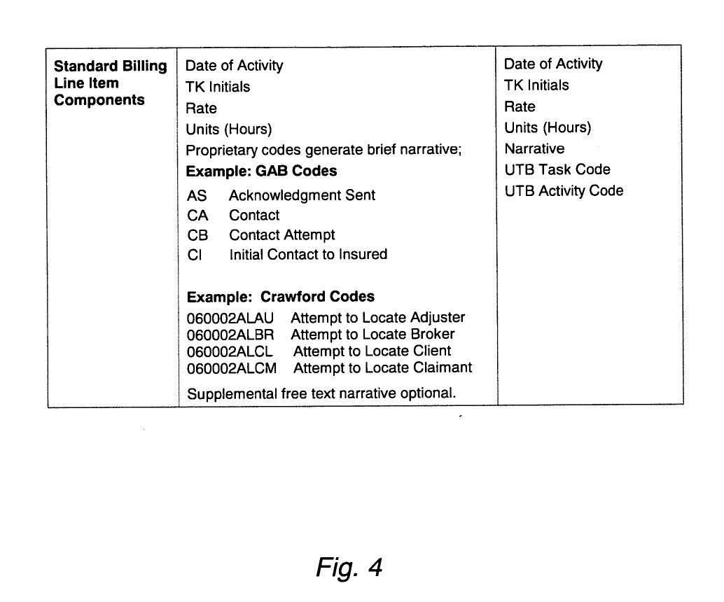

In certain embodiments, billing information may include codes corresponding to tasks and/or activities performed in conjunction with completing the tasks. A bill for a task may identify the task by a code, describe what was performed by a code, and/or list a charge or amount of time and rate to be charged. For example, a bill for a task of inspecting an accident site for an assignment of “investigate auto accident” may include: a task code, IA (“inspect accident site”); a list of what was performed, T (“travel”), P (“photograph”); and a charge $50. FIG. 4 depicts an embodiment of billing information. Billing information may include billing codes that allow a user to quickly document the status of a task. Billing codes may replace common narratives with less text. Billing codes may save companies and/or vendors money by reducing the amount of time required to create a bill or invoice.

Billing information may include rates a vendor charges for completion of a task and/or assignment. A vendor may receive a flat amount for completion of a task or assignment. A vendor may receive hourly compensation for completion of a task or assignment. In some embodiments, a vendor may receive an hourly compensation up to a maximum compensation for completion of a task or assignment. Billing rates may vary based on several factors including, but not limited to: vendor location, type of loss, type of task and/or assignment, difficulty of task and/or assignment, catastrophic loss designation, professional category of vendor, and/or type of policy coverage. In some embodiments, a professional category of a vendor may not affect billing rate.

In some embodiments, billing information may be transmitted to a computer system, such as an insurance processing system, via a network. In certain embodiments, billing information may be emailed to a computer system and/or transmitted via a website to a computer system. A user may enter billing information on a website which transmits the billing information to a computer system. A user may upload billing information to a website which then transmits billing information to a computer system.

In some embodiments, billing information may be transmitted as an XML message to a computer system. In some embodiments, billing information may be prepared in LEDES 2000 format. Billing information prepared in LEDES 2000 format may then be transmitted as an XML message to a computer system. In certain embodiments, billing information may be transmitted in a parsed format. Users may prepare billing information in parsed format using commercially available software, such as Juris and/or Timeslips, and transmit the billing information to the computer system. Billing information may be stored on a memory or in a database of the computer system.

A user may transmit billing information for one or more tasks in an assignment and/or one or more assignments. A user may transmit billing information separately for each task in an assignment. A user may transmit billing information for more than one task in one or more assignments collectively.

Billing information may include multiple invoices in a single file. In certain embodiments, a user may transmit billing information for a plurality of vendors and/or a group of vendors. A user may compile all billing information into one submission and transmit the billing information to a computer system. Billing information may be aggregated into a single file. Billing information may be an aggregate of XML files. A computer system may separate billing information from the single file and/or concurrently process billing information for multiple tasks, assignments, and/or vendors. For example, a group of independent adjusters in a city may submit billing information to one administrative person in the group. The administrative person may be an adjuster. The administrative person may transmit billing information to the insurance processing system. The administrative person may correct errors found by an audit and/or forward errors discovered by an audit of billing information to the appropriate adjuster. In one embodiment, the administrative person may receive assignments from an assignment program and distribute the assignments to the appropriate adjuster. In some embodiments, assignment program may notify a user if a transmission of billing information was not received and/or was too large.

Billing information may be audited manually or automatically. In certain embodiments, billing information may be at least partially audited on a user system prior to transmitting billing information to a computer system. Billing information may be audited after transmission to a computer system. Billing information may be at least partially processed by a computer system, such as an insurance processing system.

Auditing or an auditing program or subroutine of an assignment program may include comparing billing information to business rules, industry standards, or company specified rules regarding billing. Auditing may include reviewing format of billing information. Auditing may include analyzing billing information to ensure tasks are billable. For example, if a task includes photographing an accident site, travel time to the accident site may be billable, while travel time to obtain medical records may not be billable. In some embodiments, auditing may compare billing information to a predetermined set of billing rules to determine if billing information substantially complies with billing rules. Billing rules may vary across an industry. Industry standards may determine billing rules.

Auditing may check billing information against formatting requirements, math errors, prior submission of the same bill, prior submission of the same tasks or line items within a bill, and/or compliance with other business rules. In some embodiments, billing information may be substantially billing codes. Auditing may analyze billing codes to ensure codes used in billing information exist and/or are applicable to specified tasks and/or assignments. Auditing may examine billing information to identify activities a vendor performs outside the scope of an assignment and/or a task. Bills outside the scope of an assignment may not be automatically paid. Including bills outside the scope of an assignment may cause at least a portion of the billing information to be manually audited.

Auditing billing information may produce an error log including at least a portion of errors encountered during the audit and/or may notify a user of errors that occurred during the audit. Explanations of errors encountered during the audit may be provided to a user. A user may correct errors, submit the billing information as is, and/or choose to correct errors at a later point. A user may be able to input a reason for submitting the bill as is without correcting a discovered error. After a user modifies billing information to correct one or more errors, billing information may be audited again.

In some embodiments, a portion of errors discovered during auditing may be transmitted to a computer system, auditors, and/or a user. For example, if a user modifies a code that identifies a vendor, an error message may be transmitted to a computer system but not to the user. In certain embodiments, a user may not be notified of errors encountered during auditing. Separate auditors may examine errors encountered during auditing and/or correct errors in billing information. In some embodiments, a message may be transmitted to computer system including whether the audit was completed and/or what errors were encountered during the audit of billing information. In some embodiments, errors encountered during auditing may be included on an error log accessible through a website. A link to an error log may be transmitted to a user, auditors, and/or computer system.

In some embodiments, auditing may be performed manually. Auditing may be performed by central auditing units and/or by claim handlers. Auditors may view billing information line by line (e.g., task by task, assignment by assignment, each charge individually). Auditors may manipulate how billing information is displayed on a screen (e.g., sorting and/or filtering by various fields, such as vendor name, task type, assignment task, date submitted, billing codes, codes corresponding to tasks). An auditor may be able to enter notes and/or comments in the billing information. Auditors may be able to modify billing information and/or correct billing information containing errors. Auditors may be able to view billing information as submitted and/or all billing information currently and previously submitted for a task and/or assignment. Auditors may request additional information from a vendor to correct errors in billing. Auditors may transmit a message to a vendor. A vendor may receive the message via email or when the vendor accesses the assignment program.

In some embodiments, some billing information may be automatically audited and other billing information may be manually audited. Automatically auditing at least a portion of billing information may save a company money since standard bills may be paid without requiring human review and authorization of bills. Human resources may be focused on bills with errors or irregular bills. A company may prefer that some or all bills be manually audited. In some embodiments, only bills with errors discovered during automatic auditing are manually audited. Bills without errors may bypass manual auditing. Bills with corrected errors may bypass manual auditing. In one embodiment, if a user submits a bill as is with errors, at least a portion of the bill may be manually audited (e.g., the portion of the bill containing errors and/or any related portions). In an embodiment, if a user submits a bill as is with errors, the entire bill may be manually audited.

In some embodiments, billing information for a task may include a date of activities and/or expenses. Auditing dates of activities and/or tasks may flag or create an error message for future dates and/or incorrect date formats entered. Billing information for each task may include the professional category of the vendor. A professional category may be automatically entered in billing information (e.g., a professional category may be automatically associated with a specific vendor). Editing a predetermined professional category designation in billing information may cause an error when auditing the billing information. In some embodiments, a professional category may be compared to a company employee reference table when billing information is audited. If the professional category does not match data in the reference table, an error message may be created when the billing information is audited. In some embodiments, an auditing program may generate an error message if two or more vendors with the same professional category bill time using the same task codes and activities or narratives within the task codes on the same day in the same invoice. Auditing may refer a bill to an auditor. An auditor may manually review and/or authorize or decline all or part of a bill. Bills for a vendor that exceed twenty-four hours of time billed in a single day may be flagged as an error by an audit of billing information.

In some embodiments, billing information may include a billing rate for a task and/or assignment. Billing rates may be automatically assigned to a task, entered by a vendor, and/or selected from a reference table of rates. A reference table may include rates a company may authorize for specific tasks and/or assignments. In some embodiments, when an assignment is assigned, a billing rate for the assignment may be transmitted to the vendor. An audit of billing information may compare bills in billing information to ensure a billing rate for an assignment is not exceeded. An error message may be generated during an audit of billing information if bills exceed a total allowable for an assignment. In some embodiments, auditing billing information may include comparing rates in a reference table of rates to rates included in billing information. An error message may be generated when rates in billing information do not match rates in the reference table.

In some embodiments, flat fee billing rates may be compared to predetermined amounts to ensure rates do not exceed a budgeted amount. Error messages may be generated if flat fee billing rates exceed allowed fees. In some embodiments, some expenses that exceed budgeted or authorized amounts may not cause an error during auditing. For example, mileage expenses and photocopying expenses that exceed standard expense rates may not cause an error while auditing billing information. Billing information without errors may be fully or partially paid or authorized.

In some embodiments, billing information may be audited for compliance with industry or company standards. Billing may be reported in 0.1-hour increments. Some bill rates may be on a per diem basis. Flat rate fees may be billed as a single unit. Some expenses may be itemized. For example, the number of miles driven or photocopies made may be included in billing information. Auditing may identify fees not reported in the standard format. One or more error messages may notify a user of noncompliant or errors in billing information. A user may modify billing information to correct errors discovered during auditing.

In some embodiments, a user may transmit a report to a computer system, such as an insurance processing system. A report may be transmitted via a network, such as the Internet. In one embodiment, a report may be uploaded to a website coupled to an insurance processing system. A report may be stored in a memory of a computer system. Storing a report on a memory of a computer system may be advantageous because the report may be accessed from any computer with Internet access.

A report may include information regarding tasks assigned to a vendor, such as an adjuster. A report may include all work product of a vendor. A vendor may use a report to transmit information about completed tasks. A report may include information requested in an assigned task, such as an image of an accident scene, an image of a medical report, and/or an account of facts surrounding an insurance claim. A report may include a status of an assignment and/or timeframe for completion of tasks and/or assignments. A report may include a list of completed tasks and/or assignments. A report may include documents a vendor created and/or acquired while completing a task.

In some embodiments, the assignment program may create a billing report. A billing report may include hours billed by a specific company or vendor within a time period. A billing report may include information on when a company exceeds a predetermined amount of time billed across certain claims and/or periods of time. A billing report may include when two or more adjusters bill time for a same claim in the same day. A billing report may include vendors whose expenses exceed a predetermined amount. A billing report may help a company identify billing irregularities and/or help identify vendors who have a history of overcharging and/or submitting noncompliant bills. Vendors with a history of overcharging and/or submitting noncompliant bills may be flagged and their billing information may bypass automatic auditing and be subject to manual audits.

In some embodiments, at least a portion of bills in billing information may be automatically paid. A bill in billing information may be paid by authorizing payment to vendor bank account or by issuing a check. Bills that do not exceed a predetermined amount may be automatically paid. It may be less expensive for a company to automatically pay bills below a predetermined cost rather than investigate or manually review the bills. Bills may be paid if they meet predetermined criteria. The bills criteria may be based on industry standards or a customized set of rules. In certain embodiments, bills conforming to bills criteria may be paid. For example, bills without errors after audit or bills where all errors encountered during audit have been corrected may be automatically paid. Automatic bill payment may reduce costs for a company since a human would not need to review and authorize every bill submitted to the company. Payment authorization of at least a portion of billing information submitted to the computer system may be based on the results of the audit of the billing information. Results of the audit may indicate which bills may be automatically authorized and paid. Results of the audit may indicate which bills need further examination prior to authorizing payment.

In some embodiments, performance of a vendor may be obtained from an assignment program. Efficiency and performance quality may be obtained from information transmitted to the computer system via the assignment program (e.g., audits reveal few errors, billing information is consistently submitted in proper format, bills do not exceed budgeted amounts, bills do not include activities outside the scope of an assignment, etc.). Performance may be included in a vendor list and used to assign assignments in the future. Performance may be continuously or periodically updated. Vendor performance and/or efficiency may affect future assignments. In some embodiments, an approved vendor with many billing errors (e.g., billing errors may be discovered during the auditing procedure) may be recategorized as an unapproved vendor. Unapproved vendors may not be assigned assignments in the future.

In some embodiments, completed assignments may be automatically closed. Assignments may be reopened and/or reassigned. Tasks may be modified, added, and/or deleted when an assignment is reopened and/or reassigned.

In some embodiments, it may be desirable for an insurance company to manage assignments such as activities the company would like an adjuster to perform. An insurance company may have assignments stored on a memory of an insurance processing system. Assignments may be created in the assignment program. Assignments may be manually and/or automatically assigned to adjusters based on business rules and/or assignment rules. An email and/or message may be sent to an adjuster who receives an assignment. The email or message may include information about the assignment (e.g., tasks involved, budget for completion, general background of the facts) and/or a link to a website containing information about the assignment.

An adjuster may access an assignment program on an insurance processing system to view assignments assigned to the adjuster. An adjuster may access the assignment program via the Internet. An adjuster may enter billing information in the assignment program via one or more websites. An adjuster may transmit billing information to the insurance processing system. Adjusters may bill for tasks and/or assignments hourly or receive a flat rate for each task and/or assignment. Billing information may include the amount of time an adjuster needed to complete one or more tasks in an assignment and/or a cost of completing a task or assignment. Billing information may include billing codes which describe the activities an adjuster performed in completing the task or assignment.

Billing information may be audited manually or automatically. Automatically auditing billing information may allow bills to be more quickly paid and/or increase consistency in handling bills received by a company. Billing information may be audited before or after transmission to the insurance processing system. A user may be prompted or notified of at least a portion of errors or inconsistencies in the billing information. For example, a user may be notified if the user billed for more than twenty-four hours in one day. A user may be notified of spelling and/or grammatical errors. In some embodiments, a user may be notified if billing information includes unacceptable bills or bills for activities not requested. A user may be allowed to modify billing information to correct errors discovered during auditing. In some embodiments, a portion of bills in billing information may be automatically paid. In some embodiments, bills that do not exceed a predetermined amount may be automatically paid. Bills may be paid if they meet predetermined criteria. Automatic bill payment may reduce costs for an insurance company since a human would not need to review an authorized payment for every bill submitted to the insurance company.

In some embodiments, it may be desirable for an insurance company to manage assignments such as activities the insurance company would like an adjuster to perform. An insurance company may have assignments stored on a memory of an insurance processing system. Assignments may be created in the assignment program. Assignments may be manually and/or automatically assigned to adjusters based on business rules and/or assignment rules. An email and/or message may be sent to an adjuster who receives an assignment. The email or message may include information about the assignment (e.g., tasks involved, budget for completion, general background of the facts) and/or a link to a website containing information about the assignment.

An adjuster may access an assignment program on an insurance processing system to view assignments assigned to the adjuster. An adjuster may access the assignment program via the Internet. An adjuster may enter billing information in the assignment program via one or more websites. An adjuster may transmit billing information to the insurance processing system. Adjusters may bill for tasks and/or assignments hourly or receive a flat rate for each task and/or assignment. Billing information may include the amount of time an adjuster needed to complete one or more tasks in an assignment and/or a cost of completing a task or assignment. Billing information may include billing codes which describe the activities an adjuster performed in completing the task or assignment.

Billing information may be audited manually or automatically. Automatically auditing billing information may allow bills to be more quickly paid and/or increase consistency in handling bills received by a company. Billing information may be audited before or after transmission to the insurance processing system. A user may be prompted or notified of at least a portion of errors or inconsistencies in the billing information. For example, a user may be notified if the user billed for more than twenty-four hours in one day. A user may be notified of spelling and/or grammatical errors. In some embodiments, a user may be notified if billing information includes unacceptable bills or bills for activities not requested. A user may be allowed to modify billing information to correct errors discovered during auditing. In some embodiments, a portion of bills in billing information may be automatically paid. In some embodiments, bills that do not exceed a predetermined amount may be automatically paid. Bills may be paid if they meet predetermined criteria. Automatic bill payment may reduce costs for an insurance company since a human would not need to review and authorized payment for every bill submitted to the insurance company.

An assignment program may manage assignments from an insurance processing system of an insurance company to a vendor, such as an adjuster. Assignments may be assigned to individual adjusters or groups of adjusters to complete. Assignments may include any request for an individual to accomplish a task or activity. Assignments may include, but are not limited to, investigating an insurance claim, such as a claim arising from an automobile accident, a claim due to property loss, or a casualty claim arising from an accident; investigating an insurance policy request, such as a request for coverage of property; and/or obtaining information from policyholders. Assignments from insurance companies may also include any outsourced activities or activities performed by individuals within the insurance company.

Assignments may include information such as, but not limited to: assignment name, assignment identification code, division or division office, vendor name, vendor office, vendor code, a contact at the vendor, assignment status, date an assignment was accepted or declined, date a claim was accepted or declined, claim number, date of loss, claim handler name, claim supervisor and/or manager, description of loss, potential third party witnesses, potential third party beneficiaries, accident state, policy number, policy holder, policy state, policy limits, effective date of the policy, expiration date of the policy, type of policy, claimant name, assignment type, policy coverage of the type of claim, status of the claim, severity of the loss, nature of the injury, cause of the loss, attorneys associated with the policy holder and/or claimant, miscellaneous text fields that a user can enter information in, tasks associated with the assignment, task codes, task descriptions, task due dates, task billing rates, task completion costs, whether the task requires a adjuster with a specific professional category, and/or any special instructions.

Assignments may include one or more tasks. Tasks may include examining medical reports, examining police reports, examining the property for which insurance coverage is requested, examining accident sites, obtaining medical reports, obtaining an account of events from an insured and/or claimant, obtaining images of accident sites, obtaining images of property insurance coverage is requested for, and/or obtaining images of the property for which a loan is requested.

In some embodiments, tasks to be included in an assignment may be selectable from a list of tasks. A task list may be customizable. Tasks in a task list may be coupled to billing codes for use when submitted billing information. An assignment program may automatically include certain tasks when selecting a specific type of assignment. For example, automobile insurance claims may always include tasks such as confirming loss/damage, determine if any injuries occurred as a result of the accident, and/or obtaining a police report. Automatically creating a task list for categories of assignments may increase efficiency, increase uniformity among similar claims assigned to different adjusters, and reduce time spent entering assignments. Assignments may be obtained from a database of pending claims and/or cases. Assignments may be created in the assignment program. Tasks available to be included in an assignment may vary depending on the type of assignment and/or amount of the claim. In some embodiments, selecting tasks from a task list may automatically generate an assignment letter. When the assignment is assigned to an adjuster the assignment letter may be transmitted to the adjuster and include information about the assignment.

In some embodiments, a user may also choose to deselect recommended tasks in a task list. A user may also create custom tasks to be included in an assignment. In some embodiments, a task list may include optional tasks to reduce the number of custom tasks a user may have to create. In some embodiments, certain tasks in a task list may not be deselected. Required tasks in a task list may be based on industry custom, company policy, and/or federal or state regulations. For example, obtaining a police report may be a task that can not be deselected in an assignment to investigate an claim due to an automobile accident.

In some embodiments, tasks may also include instructions and/or a link to instructions regarding the task. A task may include information or guidelines on how to complete the task. For example, a task to obtain medical records may include contact names at several hospitals. A task to photograph an accident site may include suggestions for what types of pictures should be taken by the adjuster. Special instructions for a task may also be included and/or entered by a user. In some embodiments, custom created tasks may be automatically routed to manual audits.

Tasks may be added to pending assignments before or after assigning an assignment to a vendor. For example, an insurance company may determine that it would be beneficial to obtain a credit report for policyholders who file more than one claim or an insurance company may determine that an account of facts of the accident from all parties to an accident should be required in automobile damage claims. Tasks in pending assignments may be modified to account for the insurance companies new polices without having to create new assignments or reassign assignments. Allowing tasks to be modified after assignment may allow an insurance company to quickly implement changes in policy or procedure.

In some embodiments, assignments may be stored on a memory of an insurance processing system. Assignments may be stored in a database of an insurance processing system. In some embodiments, a vendor may interact with an insurance processing system through the Internet. Vendors may also communicate with an insurance processing system through other networks including, but not limited to, WAN or LAN.

In some embodiments, a vendor may be able to view assignments assigned to the vendor. Some vendors may have access to different features or have different permissions from other users. For example, an administrative user may be able to create and/or assign assignments to adjusters, override automatic assignments, and/or view all pending assignments. Adjusters may only be able to view assignments assigned to specific vendors, such as a group a head adjuster manages.

In some embodiments, using an assignment program may facilitate and increase effectiveness of monitoring assignments. Assignments may be manually or automatically electronically assigned to one or more adjusters. An insurance company may assign assignments based on business rules and/or factors such as, adjuster skills and/or adjuster workload. A notice or email may be sent to the adjuster may indicate an assignment has been assigned to the adjuster. Currently, insurance adjusters may receive a fax indicating what assignments have been assigned to the adjuster. In some embodiments, an adjuster may log into a website and be able to view all assignments assigned to the adjuster. Allowing adjusters access to an assignment program via website may facilitate management of task loads by individual adjusters and/or allow an insurance company to view progress in assignments from any computer connected to the Internet.

An adjuster may be able to accept or decline the assignment. An adjuster may provide a reason for declining an assignment, such as time frame assignment completion required within and/or personal relationship with the claimant. In some embodiments, a vendor may be able to ask questions about the assignment before accepting or declining the assignment. An adjuster may ask questions via XML messages and/or emails to the computer system. An adjuster may also ask questions by filling out templates on a website.

In some embodiments, an assignment program may automatically assign assignments to adjusters. In certain embodiments, assignments may be assigned at least partially based on location. A radius function may allow all adjusters in a specified region to be identified. For example, all adjusters in a zip code or within a specified distance from a location may be identified. The radius function may allow assignment of assignments to an adjuster proximate a location, such as the location of the claimant, the location of the policyholder, location of the property on which a loss is claimed, and/or the location of the accident. An insurance company may select an adjuster within a radius of a location and/or an assignment program may select an adjuster at least partially due to the vendor's proximity to a location. Allowing an insurance company to assign assignments to vendors proximate an accident or location may have several advantages including, but not limited to increasing cost efficiency since adjusters may have to travel less. It may also be beneficial to adjusters to be assigned tasks based on proximity to the adjuster, since the adjuster may be more familiar with the police in their community, the hospitals in their community, and/or places in their community. An insurance company may benefit from increased efficiency of an adjuster since they may have more familiarity with facts and people located in their community. Efficiency of an adjuster may also increase, saving the insurance company money, since the adjuster may be able to more quickly finish tasks that are similar to tasks the adjuster previously performed. For example, an adjuster may be able to get police reports from a particular city more quickly after the first time.

An assignment program may also allow users (e.g., vendors, adjusters, etc.) to enter billing information. Billing codes may be used in billing information and/or may identify common tasks and/or common amounts charged for tasks. Insurance companies use a plurality of adjusters and other vendors for a variety of activities. Each adjuster or vendor may submit bills to the insurance company in different or similar manners. Using billing codes may increase uniformity among bills from several different users and/or adjusters. Even if bills are similar but not identical in format and language they may require manual auditing. Using billing codes may allow each adjuster or vendor to identify the same task using the same billing code. Using billing codes may facilitate generation of bills since they allow an adjuster to quickly enter information and may also increase uniformity and consistency within an industry since a task or assignment with a specific billing code may always be treated similarly. When billing information is manually entered and reviewed, however, similar bills may be authorized for different amounts. Bills may also be quickly audited when tasks are uniformly described. Uniformly describing tasks and assignments using billing codes may facilitate automation. Using billing codes may decrease administrative time and increase adjuster efficiency. Adjusters may also be allowed to enter additional information in billing information. For example, if an adjuster is assigned the task of obtaining police report and a police report was not filed, then an adjuster may list the task as complete using billing codes and also enter “police report not filed.” By utilizing billing codes and a field where the adjuster can enter other information, auditing the bill may be facilitated by using the billing codes and important information, such as that a police report was not filed, may not be lost.

Billing information may include an identifier associated with the adjuster or with the professional category in which the adjuster belongs. In certain embodiments, a bill may only need to identify the professional category of the adjuster. Each professional category of adjuster may be paid differently for the same tasks, and so identification of the professional category of the vendor performing the task may be necessary for bill calculation.

In certain embodiments, billing information may include codes corresponding to tasks and/or activities performed in conjunction with completing the tasks. Often assignments are similar to assignments previously done. Tasks that need to be performed also may be similar among assignments. Therefore, a bill for a task may identify the task by a code, describe what was performed by a code, and/or list a charge or amount of time and rate to be charged or a code for the billing rate. For example, a bill for an assignment of investigating a claim for casualty loss may include: a task code, F (“obtain facts of the incident”); a list of what was performed, CONCL (“contact claimant”), CONW (“contact witness”), PR (“obtain police report”); and a charge $200. Billing information may include billing codes that allow a user to quickly document the status of a task. Billing codes may replace common narratives with less text. Billing codes may save companies and/or adjusters money by reducing the amount of time required to create a bill or invoice and facilitating automated auditing.

In some embodiments, billing information may be transmitted to an insurance processing system via a network. In certain embodiments, billing information may be emailed to the insurance processing system, transmitted via a website to the insurance processing system. In some embodiments, billing information may be transmitted as an XML message or in a parsed format. Billing information may be stored on a memory or in a database of the insurance processing system.

Billing information may be audited manually or automatically. Auditing or an auditing program or subroutine of an assignment program may include comparing billing information to business rules, industry standards, or company specified rules regarding billing. Automatically auditing at least a portion of billing information may save insurance companies money since standard bills may be paid without requiring human review and authorization of bills. Human resources may be focused on bills with errors or irregular bills. In some embodiments, billing information may be substantially billing codes. Auditing may analyze billing codes to ensure codes used in billing information exist and/or are applicable to specified tasks and/or assignments. Auditing may examine billing information to identify activities a vendor performs outside the scope of an assignment and/or a task. Auditing billing information may produce an error log including at least a portion of errors encountered during the audit and/or may notify a user of errors that occurred during the audit. A user may correct errors, submit the billing information as is, and/or choose to correct errors at a later point.

In some embodiments, a portion of errors discovered during auditing may be transmitted to the insurance processing system, auditors and/or a vendor. For example, if a vendor modifies a code that identifies professional category, an error message may be transmitted to the insurance processing system and/or auditor but not to the vendor. In some embodiments, billing information with errors may be transmitted to auditors. Auditors may manually audit billing information. An insurance company may use auditors to analyze and/or correct errors in billing information and/or authorize payment of bills. Some insurance companies may prefer that some or all bills be manually audited.

In some embodiments, a user may transmit a report to an insurance processing system. A report may be transmitted via a network, such as the Internet. In some embodiments, a report may be uploaded to a website coupled to an insurance processing system. A report may be stored in a memory of a computer system. Storing a report on a memory of an insurance processing system may be advantageous because the report may be accessed from any computer with Internet access. Furthermore, if an insurance claim is audited in the future, all information created by an adjuster may be available for use during the audit. Additionally, if an insurance claim is litigated, audited, or reevaluated information about what an adjuster did may be identified from the task list and information submitted in the report.

In some embodiments, a report may include information regarding tasks assigned to an adjuster. An adjuster may use a report to transmit information about completed tasks. A report may include information requested in an assigned task, such as an image of an accident scene, an image of a medical report, and/or an account of facts surrounding an insurance claim. A report may include a status of an assignment and/or timeframe for completion of tasks and/or assignments. A report may include a list of completed tasks and/or assignments. A report may include documents an adjuster created and/or acquired while completing a task.

In some embodiments, at least a portion of bills in billing information may be automatically paid. Bills may be paid if they meet predetermined criteria. For example, bills without errors after audit or bills where all errors encountered during audit have been corrected may be automatically paid. Payment authorization of at least portion of billing information submitted to the computer system may be based on the results of the audit of the billing information. Automatic bill payment may reduce costs for an insurance company since a human would not need to review and authorize every bill submitted to the insurance processing system. Furthermore, adjusters may benefit from a time reduction between bill submission and payment.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of managing assignments comprising:
accessing assignments through a user system;
assigning one or more assignments to an adjuster, wherein an assignment comprises one or more tasks to be completed by the adjuster;
transmitting billing information for an assignment from a user system to an insurance processing system; and
auditing the billing information.

2. The method of claim 1, wherein accessing assignments comprises accessing assignments stored on a memory of an insurance processing system.

3. The method of claim 1, wherein accessing assignments comprises accessing assignments stored on a memory of an insurance processing system via one or more Internet protocols.

4-5. (canceled)

6. The method of claim 1, further comprising automatically assigning one or more assignments to an adjuster.

7. The method of claim 1, further comprising adding one or more tasks to an assigned assignment.

8. The method of claim 1, wherein an assignment comprises an insurance claim.

9-10. (canceled)

11. The method of claim 1, wherein a task comprises investigating an accident site.

12-14. (canceled)

15. The method of claim 1, wherein billing information comprises one or more billing codes, wherein a billing code is configured to be assigned to a task.

16. The method of claim 1, wherein billing information comprises an amount of time the adjuster spent on an assigned task.

17. (canceled)

18. The method of claim 1, wherein billing information comprises a price the adjuster charges for completing an assigned task.

19. The method of claim 1, wherein billing information comprises amounts of time a plurality of adjusters spent on a plurality of assignments.

20. The method of claim 1, wherein billing information comprises a professional category of the adjuster.

21. (canceled)

22. The method of claim 1, further comprising:
accessing business rules; and
automatically auditing the billing information, wherein automatically auditing the billing information comprises applying business rules to the billing information.

23. The method of claim 1, wherein billing information is automatically audited prior to transmitting billing information to the insurance processing system.

24. The method of claim 1, further comprising:
automatically auditing billing information prior to transmitting billing information to the insurance processing system;
notifying a user of errors in billing information; and
allowing a user to modify billing information to correct errors in billing information.

25. (canceled)

26. The method of claim 1, wherein the billing information comprises one or more bills corresponding to one or more tasks, and further comprising automatically paying at least one bill.

27. The method of claim 1, further comprising transmitting a report from the user system to the insurance processing system, wherein the report comprises information requested in the assigned assignment.

28. The method of claim 1, further comprising transmitting a report from the user system to the insurance processing system, wherein the report comprises completed tasks.

29. (canceled)

30. A carrier medium comprising program instructions, wherein the program instructions are executable to implement:
accessing assignments through a user system;
assigning one or more assignments to an adjuster; wherein an assignment comprises one or more tasks to be completed by the adjuster;
transmitting billing information for an assignment from a user system to an insurance processing system;
auditing the billing information.

31-57. (canceled)

58. An insurance processing system comprising:
a CPU;
a memory coupled to the CPU, wherein the memory comprises program instructions executable to implement:
accessing assignments through a user system;
assigning one or more assignments to an adjuster; wherein an assignment comprises one or more tasks to be completed by the adjuster;
transmitting billing information for an assignment from a user system to an insurance processing system; and
auditing the billing information.

59-155. (canceled)
